(19) United States
(12) Patent Application Publication
(10) Pub. No.: US 2003/0039945 A1
(43) Pub. Date: Feb. 27, 2003

(54) Method for imparting knowledge

(75) Inventors: Anil Kumar Dang, New Delhi (IN); Navtej Matharu, New Delhi (IN); Ramesh Chandra Malhotra, New Delhi (IN)

Correspondence Address: GREENBLUM & BERNSTEIN, P.L.C., 1941 ROLAND CLARKE PLACE, RESTON, VA, 20191, US

(73) Assignee: QUANTUM INFORMATION SYSTEMS, Ltd., New Delhi (IN)

(21) Appl. No.: 09/935,630

(22) Filed: Aug. 24, 2001

(51) Int. Cl. G09B 19/00; G06F 15/18

(52) U.S. Cl. 434/118

(57) ABSTRACT

The present invention relates to a novel method for imparting knowledge. Most specifically, the invention relates to an efficient method and an approach for imparting education through a network system in conjunction with a human network.

### FIELD OF THE INVENTION

The present invention relates to a novel method for imparting knowledge. Most specifically, the invention relates to an efficient method and an approach for imparting education through a network system in conjunction with a human network.

### BACKGROUND AND PRIOR ART OF THE INVENTION

The traditional method of imparting education involves establishment of educational institutions wherein students attend classes and individual courses are taught by a single teacher or several teachers for one or more course. This system of education is almost universally followed and remains an efficient method for imparting education. The system allows peer interaction between students and creates competition between them. Students also have the opportunity to contact the teacher immediately for clarification of their doubts. Feed-back and response is received immediately. The sessions are interactive, the students are by and large attentive and subject comprehension is high. The teacher knows each student individually, and is aware of their potential and limitations especially if the class size is small.

However, the traditional system as outlined above has several disadvantages. One major disadvantage is that a single teacher is expected to impart knowledge to a large number of students. As a result attention given per student decreases with an increase in the number of students. Another major disadvantage of the traditional system is that the teacher is confined to a single location. Hence he can teach efficiently only those students who are physically able to reach his class. Clearly the capacity of a teacher to effectively impart education to a large number of students at different locations is limited.

Teaching is in reality an art. One observes that good teachers develop good students. On account of geographic and other limitations, students at remote locations are unable to attend a given course in a given educational institution even though they maybe fully aware of the high quality of education being imparted in that institution. As a consequence, the number of high quality students produced by that particular institution remains limited, resulting in low utilization of high quality resources in the form of a good teacher.

Students who are unable to be physically present in a class taught by a good teacher in view of geographic constraints, should ideally not be deprived of the quality education being imparted by the teacher. For example, students in villages are compelled to attend local schools primarily because urban schools are not accessible to them. It is, therefore, advantageous to evolve a system of education wherein students at distant places can also receive quality education without physically attending the classes at the place wherein such education is being imparted. In view of rapid advances in technology, Technology-Driven “Distance learning” is fast becoming possible thus enabling individuals desirous of obtaining higher or specialized education access high quality educational institutions that are located at distant places.

The prior art is replete with instances of different types of distance education systems. For example, U.S. Pat. No. 4,785,472 describes a remote teaching system including a teacher's station and a plurality of student stations which may be located at sites remote from one another. Each station includes a speaker telephone or some other voice telephone set which is connectable to a telephone system for voice communication among the various stations. Each station also includes a video display monitor and a video media player connected to the video display monitor. Each student station also includes a video media player control alert connected to the video media player of the student station. The teacher station also includes a video media player master controller connected to the teacher station video media player. The video media player master controller located at the teacher station and the video media player controller located at the student stations are connected to the telephone system. Audio signals are transmitted and received over the telephone system, so that playing of the teacher station video media player and the student station video media players can be synchronized. The lesson prepared by a teacher are video taped and multiple copies of the taped lesson are prepared with one copy being provided to each student station and one to the teacher station. If a student has a question about a point in the lecture playing on the video tape cassette player, he/she can speak to the teacher over his/her voice telephone set at a distant site to ask the question.

The remote teaching system disclosed in U.S. Pat. No. 4,785,472 has a number of significant drawbacks. For example, the use of prerecorded lectures significantly reduces the interpersonal nature of a classroom type lecture. Furthermore, the remote teaching system does not provide a visual link between the teacher at the teaching station and the students in remote locations.

Another “On-line” tutorial system for providing instructions is disclosed by U.S. Pat. No. 5,535,422 wherein software guides a user through one or more examples of the product operation. This system is a computer implemented interactive tutorial system wherein instruction is provided on-line along with monitoring and user assistance. One major disadvantage of this system is that it involves interaction between the user and the computer only. No teacher is involved as in a traditional class room setting, because the software is capable of assisting the user. Peer interaction and the resultant competitive spirit which is observed in a traditional class room system is completely absent in this kind of On-line tutorial system.

A similar tutorial system is disclosed by U.S. Pat. No. 5,493,658 and U.S. Pat. No. 5,442,759 wherein the On-line tutorial system controls the resources of a data processing device to present the information in the tutorial lesson. It also monitors the user input and provides input assistance upon request.

U.S. Pat. No. 5,850,250 provides a video distance learning class room system which permits virtual contact between a teacher present in a traditional class room and students in one or more remote location. According to this system, audio and video information originating from a single location is broadcast over a communication network to any number of remote locations.

A similar tutorial system is covered by U.S. Pat. No. 5,833,468 wherein a system for remote communication between a host and a client, comprising a host facility for integrating the data to be supplied to the client into vertical blanketing intervals of a television signal and broadcasting the integrated television signal, is provided. In this system, the client receives the broadcast integrated television signal and separates the signal into a standard television signal and the to be supplied data. Eventually, the client transmits information to the host facility by connecting to a network that is linked with the host facility.

Yet another network based intelligence tutoring system is covered by U.S. Pat. No. 6,014,134 wherein assistance is provided to a user undergoing training in software development techniques. This invention allows direct manipulation by the user using a graphical user interface such as some Internet protocol.

The various systems described above are for distance learning programs that operate by using the Internet or the web. They can all be primarily classified in the category of “do-it-yourself style” of learning. The missing component in all these systems is the active interaction of the student with the teacher which is one of the key elements in the traditional system of imparting education.

Another popular method for imparting distance education is based on the broadcast of lectures on a TV network such as Zed TV wherein a teacher teaches in a class room and the lesson is broadcast in the form of a television signal to various remotely located receiving stations. Although many of the attractive features in the traditional method of imparting education are present in this method, the attribute of peer competition is completely lacking; also the education does not lead to the acquisition of a degree as is obtained by attending regular classes in the traditional system. Accordingly, there is a need for a system wherein the intrinsic advantages of a traditional class room system are synchronized with a distance learning system in order to provide a virtual campus wherein quality education leading to the award of a degree on completion of the course can be imparted to a large body of students.

### OBJECTS OF THE INVENTION

The main object of the current invention is to provide a novel method of imparting knowledge which combines the advantages of a traditional classroom system with the advantages of distance learning.

Another object of the invention is to provide a powerful networking system for imparting quality knowledge based education to a mass body of students.

Yet another object is to provide a method wherein students at remotely located places can be given access to knowledge based education as an outreach program of a traditional university.

Yet another object is to provide an education system which is cost-effective.

### DETAILED DESCRIPTION OF THE INVENTION

Accordingly, the invention provides a virtual campus for imparting high quality knowledge and a method for imparting the knowledge. More particularly, the invention provides a virtual campus comprising a combination of: (i) a system for receiving knowledge content at a remote location from any quality institution anywhere in the world in digital format; and (ii) a second source of knowledge in the form of having an expert in the field in which the knowledge is being imparted situated at a location distant from the first. This said second source is capable of receiving, transmitting and imparting knowledge based on the knowledge received from the first source.

The invention provides a method for imparting knowledge, said method comprising the steps of:

(a) providing a first source of knowledge capable of transmission in the form of live or recorded instructions, to knowledge receivers at the place of the first source of knowledge and at remote second source of knowledge at remote loci, said knowledge receivers receiving the knowledge simultaneously or within a predetermined duration, wherein the knowledge imparted by the first source at the same place and the second source are identical,

(b) the knowledge receiver at the second source interacts with the first source knowledge source as if the knowledge receiver is located at the first source of knowledge and substantially adheres to the same scheme and deadlines prescribed to the knowledge receiver at the first source of knowledge,

(c) the mode of communication between the knowledge receiver at the second source and the knowledge receiver at the first source or the first source of knowledge is through electronic media,

(d) the knowledge receiver at the second source is assisted by moderator(s), said moderators being specialized in the field of the first source of knowledge,

(e) the knowledge receiver at the second source is evaluated periodically at the first source of knowledge in the same manner as the knowledge receiver at the first source, and when the knowledge receiver at the second source fulfills the requirements of the first source of knowledge, is awarded with an undifferentiated degree, thereby creating a virtual classroom in a remote loci.

Specifically, the invention provides an interactive method for imparting knowledge, said method comprising the steps of:

(a) providing a first source of knowledge in the form of an instructor having access to a means for transmitting the knowledge or instruction to remote loci, and

(b) at least one second source of knowledge, comprising a moderator having access to a means for receiving the knowledge imparted by the primary source and then facilitating in imparting the knowledge of the primary source to students located at a place remote from the primary source.

As such, the invention relates to a method for imparting knowledge, said method comprising the steps of:

(a) providing a first source of knowledge capable of transmission in the form of live or recorded instructions, to knowledge receivers at the same place and/or at remote loci, said knowledge receivers receiving the knowledge simultaneously or within a predetermined duration, wherein the knowledge imparted by the first source at the same place and remote loci are identical, and

(b) one second source of knowledge, capable of imparting complementary and/or supplementary instructions to the knowledge receiver located at the remote loci, and also capable of interacting with the first source of knowledge, as and when required, to confirm, clarify or acquire more knowledge from the first knowledge source.

In an embodiment, the method comprises one or more third sources of knowledge located at remote loci and linked to the first and second sources of knowledge.

In another embodiment, the first source of knowledge is an instructor.

In still another embodiment, the instructions imparted by the first source are collected by audio-visual means.

In another embodiment, the instructions imparted by the first source of knowledge to the second and third sources of knowledge, are transmitted using means selected from transverse electromagnetic waves, electrical signals, coherent light signals, broadcasting signals.

In yet another embodiment, the means of transmission is internet, post and telephone cables.

In still another embodiment, the second and third sources of knowledge are instructors.

In another embodiment, the second source of knowledge is located at more than one remote loci and the instructions imparted by the first source of knowledge are transmitted either directly or through the second source of knowledge to each of the remote loci.

In still another embodiment, the second source of knowledge is a moderator.

In another embodiment, the second source of knowledge is a lead moderator and the third source of knowledge is a regional moderator.

The invention also provides a system for imparting knowledge comprising a combination of:

(i) first means for imparting knowledge, and

(ii ) second means for receiving knowledge from the first means, located at any remote location and capable of providing knowledge to supplement or complement the first means.

The system further comprises one or more means to impart knowledge located at remote loci and linked to the first and second means of knowledge.

In the system, the first means of knowledge is an instructor.

In the system, the instructions imparted by the first means are collected by audio-visual means.

In the system, the instructions imparted by the first means to the second and third means, are transmitted using means selected from transverse electromagnetic waves, electrical signals, coherent light signals, broadcasting signals.

In the system, the means of transmission is internet, post and telephone cables.

In the system, the second and third means are instructors.

In the system, the second means is located at more than one remote loci and the instructions imparted by the first means are transmitted either directly or through the second means to each of the remote loci.

In the system, the second source of knowledge is a moderator.

In the system, the second means is a lead moderator and the third means is a regional moderator.

In the system, comprising additional means located at the first and second means for imparting knowledge such as a library, audio-video systems.

The scope of the invention also extends to a virtual-campus comprising a combination of:

i. one or more classrooms with students,

ii. said classrooms being provided with means for providing instructions received from a remote source, and

iii. a moderator present in the classroom for supplementing or complementing the instructions received from the remote source.

In the campus, campus as claimed in claim 22 wherein the remote source is a classroom comprising students, recording and transmitting means and an instructor for imparting knowledge to the students.

In the campus, the remote source and the classrooms are linked by internet or cable.

In the campus, the means for imparting knowledge in the classroom is an audio visual means such as television, projector.

In the campus, comprising one or more extension classrooms located at places remote from the classroom and the remote source.

In the campus, the extension classroom comprises students, recording and transmitting means and an instructor for imparting knowledge to the students.

In the campus, each of the extension classrooms comprise regional moderators who report to a lead moderator available at the classroom.

The campus further comprises library or audio-visual systems to impart additional knowledge to the students.

In the campus, the projects are executed jointly by the students from the classroom or the students from the extended classroom with the students of the remote source.

In the campus, the students at the classroom and the extended classroom are assessed and degree is awarded by the instructor at the remote classroom.

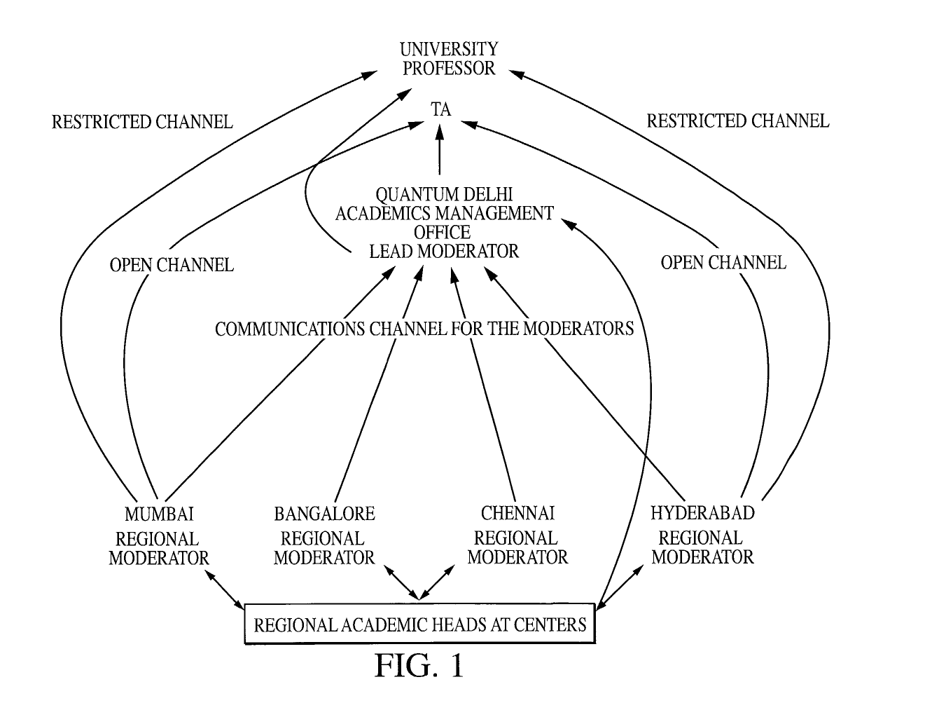

Thus, what is envisaged according to the invention is a system of education wherein knowledge is imparted by marrying the traditional class room system with modern technology which adds new elements of information dissemination which enables the connection of the finest centers of knowledge with the brightest and most receptive minds, irrespective of geography and distance while retaining the rigor and feel of the campus. For a better understanding of the system the preferred embodiments of the invention are illustrated in the flow chart depicted in FIG. 1.

The proposed method of imparting education is cost-effective and also ensures that the bulk of student queries and administrative issues are handled locally, thereby resulting in a reduction in the load on the University or Content provider thus ensuring scalability of the model.

The primary object of the invention is to enable students at different geographic locations obtain the same quality of education as would be available to them at the location of the content provider had they the financial capacity to travel and partake of the same. Students at distant places who are unable to travel to the University were erstwhile only able to partake of the education given by the remote content provider through the “correspondence mode”. In most cases the diplomas awarded at the end of the course to these remote correspondence mode students were not accepted in the marketplace as being on par with those awarded to students attending regular classes at the location of the content provider.

The system of education covered in the present invention has been designed to bridge the gap between “Knowledge Centers” and students. The invention purports to provide a system wherein courses conducted by a specific University “X” at a specific location are made available to students at different places remote from the location of the university. To achieve this end, live lectures held in classes at any specific University are recorded in the form of digital streaming video and audio and transmitted through the Internet. The lectures so communicated are received by one or more knowledge center, which the applicants to call as “virtual campuses” established at different locations away from the main University ‘X’. These virtual campuses are equipped with video display units, transmitters, internet facilities, books and all sorts of equipments that can be found in a traditional university. Each of these virtual campuses receive, the lectures given at University ‘X’ on their systems. The virtual campuses, in turn, enroll students desirous of acquiring the education being imparted by university X.

The virtual campus also appoints one or more moderators who are well versed with the subjects intended to be taught. In the presence of the said moderator(s), the lecture as delivered at University ‘X’ is projected on a wide screen in a class-room. The moderator is provided with the necessary control to pause the lecture at any time, should any student raise any query. The moderator may, if he/she feels necessary, pause the lecture to add his/her own explanatory notes in the form of an “on-the-spot” explanation. The role of the moderator is not to “teach”, because the teaching has been done by the lecturer at the university His/her role is to serve as a facilitator to assist the students to better understand the subject matter and to clear doubts in respect of the subject being taught

The moderator also serves to bridge any cultural gap that might exist between the teacher at the university and the remote students from distant countries with diverse cultural backgrounds.

The moderator primarily serves as a local resource person who is familiar with the situation on the ground and shoulders part of the load of the Professor and the TA at the University. This makes the program scaleable to any number of learning centers.

This system ensures that the remote students are an integral part of the course conducted at the parent class-room where the lecture was originally delivered.

The quality of students in the virtual campus is ensured by basing enrollment of the remote students on the same basis as on the university campus including the conduct of an Admission test.

The system of moderation ensures that students in the virtual campus have access to essentially the same inputs as the students at the University campus. The students do not completely miss the interaction between the instructor and themselves, which is an integral part of traditional classroom education as the moderator's serves as “surrogate” professors.

Besides the scheduled screening of the lectures in the classroom, it is possible for students in the virtual campus to repeatedly access the lectures on their multimedia workstations on a continuous 24-hour basis throughout the semester. Students of the virtual campus can also access all lectures of previous semesters by borrowing the CDs on which they are archived for future use.

Assessment of the knowledge internalization by the students is through midterm and end semester written examinations which are identical to those taken by fellow students on the campus conducted by the parent University ‘X’. These examinations are conducted more or less in sync with the examinations being conducted on the campus. The degree awarded on completion of the program is the same.

By extending the above concept of education to students, it is possible, according to a preferred embodiment of the invention, to extend the virtual campus into various regional centers that impart the same quality of education.

It is contemplated that each regional center, in turn, replicates the central virtual campus in terms of equipment and infrastructure The class rooms at these centres are also fitted with a video projection equipment. The lectures of the parent University ‘X’ as received at the virtual campus are subsequently accessed by the regional centers from the virtual campus or alternatively directly maybe downloaded regional centers from university. The students at each of these regional centers are also admitted on the same basis as the students of the parent University ‘X’ or those at the central virtual campus. The students at these regional centers also have Access to a moderator in the same manner as those students at the central virtual campus. A Lead moderator for each course is also named from amongst all moderators for a given subject. The lead moderator coordinates functioning of all the regional moderators. He serves as a single point contact with the professor at the parent University ‘X’ and the regional moderators. The idea of a lead moderator is to reduce overlapping of communication with the professor and to increase interaction between the regional centers themselves.

Apart from the provision of face-to-face interaction through the moderators who serve as a substitute for the professor, there are many other support systems in place to make it possible for students to better internalize knowledge at the level of a graduate degree so as to enable students at remote locations to earn an undifferentiated degree vis-à-vis a student at the parent University ‘X’.

Besides the lectures, internalization of knowledge is through imbibing homework assignments, machine problems and doing individual and group projects which are identical to those done by students at the University Access to such assignments etc is in the electronic form on the course website maintained by the professor and the TA at the university. The work is submitted electronically by the remote student to the University after completion as on the schedule followed by the university students. students with regard to group projects the remote student are often paired with students on campus, and access centers to form virtual teams.

The grading of assignments, machine problems, projects, quizzes, mid-term and final examinations is done by the same graders on campus as for campus based students and is relative to the entire class, thus ensuring that not only are the educational inputs the same as on campus but that the assessment mechanism is the same thus leading to the award of an undifferentiated degree.

Both on campus and remote students access their grades using the electronic grade book on the course website. The grades are displayed through aliases so that each student can know only his grade with respect to the grades of the entire class without knowing the actual grades of any of his classmates.

All remote students are assigned a Netid and a password to enable them to connect to the computers of the University as well as the digital library at the university.

The midterm and the final examinations for each course are proctored at central virtual campus and the regional centres are the and only papers exchanged with the university in The form of hard copies.

To ensure regular interaction between the students across centers as well as with the University Various forms of modern technology such as instant messenger and net meeting may be used This makes it possible for students to remain abreast with their peers thereby promoting peer competition not only at an individual learning center level but also across all the remote centers this also encourages the formation of geographically distributed project groups, it also encourages students to ask questions especially those that are shy as the questioning can be done anonymously too.

Review sessions similar to the ones conducted on campus between the Professor and the students can also be periodically conducted between the professor and all the remote students, simultaneously with all virtual campuses using streaming audio (from the side of the University) and chat tools (from all the centers.)

All system and course software is made available at the virtual campuses, to ensure that homework assignments, machine problems and serious project work can be completed successfully within the University stipulated deadlines.

The foregoing description is considered illustrative of some of the preferred embodiments of the invention. Various modifications and changes that can be readily made by a person skilled in the art, are considered to be encompassed within the scope of the present invention. Accordingly, the embodiments illustrated above is not desired to limit the scope of the invention to the exact features as herein described. Suitable modifications and equivalents may be resorted to, within the scope of the invention.

### EXAMPLE 1

Assume for instance Course A is conducted by the parent University X. Virtual campuses are established at several places remote from the parent University X. One such virtual campus is situated at Y. The virtual campus has all the facilities available in a school or a University, such as library, teachers, video-filming instruments, etc.

Before conduct of Course A, students at University X have to pass through a screening test. The students at all the virtual campuses including the virtual campus Y are subjected to the same screening tests. The results of the screening test are sent to the University for evaluation. The evaluation is done on a whole scale basis considering the students who took the test at University X as well as the students at the respective virtual campuses. Based on the performance in the screening test, the students are enrolled for the Course A at University X and at the concerned virtual campuses including the virtual campus Y.

Course A comprises a certain number of subjects with a prescribed syllabus which is adhered to at all the virtual campuses and virtual campus Y. Thus, the course conducted at University X is taken by the students at University X as well as at each of the virtual campuses.

The lecture at University X is recorded at the time the lecture is delivered by the teacher. This recorded lecture is then sent to each of the virtual campuses by Internet or any such appropriate medium. Thereafter, the virtual campuses display the lecture to the students on a wide screen. A moderator is present in the class room at the time when the lecture is displayed. When the lecture is conducted, the students are taught by the Professor at the University X. If any student has any question or doubt, the moderator has control to pause the lecture and solve the problem of the student. The moderator may also add his own explanation or examples. The lectures are held at the same time or immediately after conduct of the lecture at the University X.

All the lectures are stored in CDs which enable the students to replay and see the lectures whenever required. The students are allocated various assignments and projects by the University as part of the curriculum. In projects, students from virtual campuses are often clubbed with the students at the University X. Notes are exchanged through Internet. Students at the virtual campuses actively interact with the students at the University. Mid-term/Semester Examinations are conducted by the virtual campuses at the same time as in University X. The question papers are set by the University and sent across to each of the virtual campuses. The students at the University and the virtual campuses take the examination together. The students are subjected to evaluation at the same time because all the answer-books are evaluated by the University. At the end of the Course, the students are awarded a degree, which degree is the same that awarded to the University.

### EXAMPLE 2

Extension of the virtual campus is possible wherein virtual campus functions as a central or a nodal agency co-coordinating with several regional centres. At this stage, the students are enrolled based on the results of the screening test conducted at the central virtual campus and at each of the regional virtual campuses. The regional virtual campuses are operationally linked to the central virtual campus. Each of the regional campuses has a moderator. When the lectures are received by the central virtual campus, they are, in turn, relayed or transmitted to the respective regional centres so that the students at the regional campuses can use the lectures in the same way as the students at the central virtual campus. The students and the moderator at the regional campuses also have the capacity the pause and take the lectures as the central virtual campus. The students at the regional campuses also take the same mid-term and final tests as the students at the central virtual campus and University X.

1. A method for imparting knowledge, said method comprising the steps of:
(c) providing a first source of knowledge capable of transmission in the form of live or recorded instructions, to knowledge receivers at the same place and/or at remote loci, said knowledge receivers receiving the knowledge simultaneously or within a predetermined duration, wherein the knowledge imparted by the first source at the same place and remote loci are identical, and
(d) one second source of knowledge, capable of imparting complementary and/or supplementary instructions to the knowledge receiver located at the remote loci, and also capable of interacting with the first source of knowledge, as and when required, to confirm, clarify or acquire more knowledge from the first knowledge source.

2. A method as claimed in claim 1 further comprising one or more third sources of knowledge located at remote loci and linked to the first and second sources of knowledge.

3. A method as claimed in claim 1 or 2 wherein the first source of knowledge is an instructor.

4. A method as claimed in claim 1 wherein the instructions imparted by the first source are collected by audio-visual means.

5. A method as claimed in claim 1 wherein the instructions imparted by the first source of knowledge to the second and third sources of knowledge, are transmitted using means selected from transverse electromagnetic waves, electrical signals, coherent light signals, broadcasting signals.

6. A method as claimed in claim 1 wherein the means of transmission is internet, post and telephone cables.

7. A method as claimed in claim 1 wherein the second and third sources of knowledge are instructors.

8. A method as claimed in claim 1 wherein the second source of knowledge is located at more than one remote loci and the instructions imparted by the first source of knowledge are transmitted either directly or through the second source of knowledge to each of the remote loci.

9. A method as claimed in claim 1 wherein the second source of knowledge is a moderator.

10. A method as claimed in claim 2 wherein the second source of knowledge is a lead moderator and the third source of knowledge is a regional moderator.

11. A system for imparting knowledge comprising a combination of:
(a) first means for imparting knowledge, and
(b) second means for receiving knowledge from the first means, located at any remote location and capable of providing knowledge to supplement or complement the first means.

12. A system as claimed in claim 11 further comprising further comprising one or more means to impart knowledge located at remote loci and linked to the first and second means of knowledge.

13. A system as claimed in claim 11 or 12 wherein the first means of knowledge is an instructor.

14. A system as claimed in claim 11 wherein the instructions imparted by the first means are collected by audio-visual means.

15. A system as claimed in claim 11 or 12 wherein the instructions imparted by the first means to the second and third means, are transmitted using means selected from transverse electromagnetic waves, electrical signals, coherent light signals, broadcasting signals.

16. A system as claimed in claim 11 wherein the means of transmission is internet, post and telephone cables.

17. A system as claimed in claim 11 wherein the second and third means are instructors.

18. A system as claimed in claim 11 wherein the second means is located at more than one remote loci and the instructions imparted by the first means are transmitted either directly or through the second means to each of the remote loci.

19. A system as claimed in claim 11 wherein the second source of knowledge is a moderator.

20. A system as claimed in claim 19 wherein the second means is a lead moderator and the third means is a regional moderator.

21. A system as claimed in claim 11 further comprising additional means located at the first and second means for imparting knowledge such as a library, audio-video systems.

22. A virtual-campus comprising a combination of:
(i) one or more classrooms with students,
(ii) said classrooms being provided with means for providing instructions received from a remote source, and
(iii) a moderator present in the classroom for supplementing or complementing the instructions received from the remote source.

23. A campus as claimed in claim 22 wherein the remote source is a classroom comprising students, recording and transmitting means and an instructor for imparting knowledge to the students.

24. A campus as claimed in claim 22 wherein the remote source and the classrooms are linked by internet or cable.

25. A campus as claimed in claim 22 wherein means for imparting knowledge in the classroom is an audio visual means such as television, projector.

26. A campus as claimed in claim 22 further comprising one or more extension classrooms located at places remote from the classroom and the remote source.

27. A campus as claimed in claim 22 wherein the extension classroom comprises students, recording and transmitting means and an instructor for imparting knowledge to the students.

28. A campus as claimed in claim 26 wherein each of the extension classrooms comprise regional moderators who report to a lead moderator available at the classroom.

29. A campus as claimed in claim 22 further comprising library or audio-visual systems to impart additional knowledge to the students.

30. A campus as claimed in claim 22 wherein projects are executed jointly by the students from the classroom or the students from the extended classroom with the students of the remote source.

31. A campus as claimed in claim 22 wherein the students at the classroom and the extended classroom are assessed and degree is awarded by the instructor at the remote classroom.

32. A method for imparting knowledge, said method comprising the steps of:
(a) providing a first source of knowledge capable of transmission in the form of live or recorded instructions, to knowledge receivers at the place of the first source of knowledge and at remote second source of knowledge at remote loci, said knowledge receivers receiving the knowledge simultaneously or within a predetermined duration, wherein the knowledge imparted by the first source at the same place and the second source are identical,
(b) the knowledge receiver at the second source interacts with the first source knowledge source as if the knowledge receiver is located at the first source of knowledge and substantially adheres to the same scheme and deadlines prescribed to the knowledge receiver at the first source of knowledge,
(c) the mode of communication between the knowledge receiver at the second source and the knowledge receiver at the first source or the first source of knowledge is through electronic media,
(d) the knowledge receiver at the second source is assisted by moderator(s), said moderators being specialized in the field of the first source of knowledge,
(e) the knowledge receiver at the second source is evaluated periodically at the first source of knowledge in the same manner as the knowledge receiver at the first source, and when the knowledge receiver at the second source fulfills the requirements of the first source of knowledge, is awarded with an undifferentiated degree, thereby creating a virtual classroom in a remote loci.
